(19) United States
(12) Patent Application Publication
(10) Pub. No.: US 2026/0175201 A1
(43) Pub. Date: Jun. 25, 2026

(54) CATALYST FOR SYNTHESIS GAS PRODUCTION VIA CARBON DIOXIDE HYDROGENATION REACTION, METHOD FOR MANUFACTURING THEREOF, AND METHOD FOR SYNTHESIS GAS PRODUCTION

(71) Applicant: KOREA INSTITUTE OF ENERGY RESEARCH, Daejeon (KR)

(72) Inventors: Kee Young KOO, Daejeon (KR); Un Ho JUNG, Daejeon (KR); Yong Ha PARK, Cheonan-si (KR); Ye Ji CHOI, Daejeon (KR); Gi Dong SIM, Gimhae-si (KR)

(73) Assignee: KOREA INSTITUTE OF ENERGY RESEARCH, Daejeon (KR)

(21) Appl. No.: 19/308,868

(22) Filed: Aug. 25, 2025

(30) Foreign Application Priority Data
Sep. 12, 2024 (KR) 10-2024-0124675

(51) Int. Cl. B01J 23/78; B01J 23/745; B01J 35/30; B01J 35/61; B01J 35/63; B01J 37/02; B01J 37/03; B01J 37/04; B01J 37/08; C01B 32/40

(52) U.S. Cl. CPC B01J 23/78; B01J 23/745; B01J 35/394; B01J 35/613; B01J 35/615; B01J 35/633; B01J 35/635; B01J 37/0236; B01J 37/031; B01J 37/04; B01J 37/08; C01B 32/40

(57) ABSTRACT

An embodiment of the present invention provides a Reverse Water Gas Shift (RWGS) reaction catalyst, comprising: a composite metal oxide support; and metal or metal oxide nanoparticles dispersed on a surface of the composite metal oxide support or within pores thereof, wherein the composite metal oxide support is derived from a layered double hydroxide comprising copper and at least two metals different from copper, and wherein the metal nanoparticles are reduced from the composite metal oxide support.

### BACKGROUND

### 1. Technical Field

The present invention relates to a catalyst technology for producing synthesis gas via a carbon dioxide hydrogenation reaction, and more particularly, to a multi-component metal catalyst which has high efficiency for a hydrogenation reaction of carbon dioxide and is capable of reacting in a relatively low-temperature region, a method for preparing the same, and a method for producing synthesis gas via a carbon dioxide hydrogenation reaction utilizing the catalyst.

### 2. Related Art

Synthesis gas (syngas) is a main raw material for energy and chemical processes, and at present, it is common to produce it using fossil fuels.

By reacting carbon dioxide directly captured from the atmosphere with green hydrogen to produce synthesis gas, which is a high value-added compound, it is possible to reduce the carbon dioxide concentration in the atmosphere and, at the same time, establish a sustainable petrochemical process.

Interest in e-fuels, which are liquid fuels (such as diesel and gasoline) produced from carbon dioxide through a hydrocarbon production process that uses carbon dioxide-derived synthesis gas as a raw material, is increasing.

Carbon dioxide-derived synthesis gas can be produced through a Reverse Water Gas Shift (RWGS) reaction, and since the RWGS reaction is an endothermic reaction, a high-temperature reaction is necessary to enhance the conversion of carbon dioxide and the selectivity for carbon monoxide. Considering the economics of the process and the operating temperature (generally 200 to 300° C.) of a downstream Fischer-Tropsch Synthesis (FTS) process for e-fuel production, it is considered effective to lower the RWGS reaction temperature to 400° C. or lower.

The typical operating temperature of an RWGS process of the conventional art is 600 to 800° C., and to enhance the energy efficiency and economics of the process, the development of a catalyst that exhibits high carbon dioxide conversion and carbon monoxide selectivity at a temperature of 450° C. or lower is required. For the development of such low-temperature RWGS catalysts, precious metals such as Pt, Pd, and Rh are widely used; however, since these have the disadvantages that the price of the raw materials is high and their supply is limited, the development of non-precious metal-based low-temperature RWGS catalysts is required.

### SUMMARY

The present invention has been devised to solve the aforementioned problems, and an embodiment of the present invention provides a Reverse Water Gas Shift (RWGS) reaction catalyst for producing synthesis gas via a carbon dioxide hydrogenation reaction

In addition, another embodiment of the present invention provides a method for preparing the Reverse Water Gas Shift reaction catalyst for producing synthesis gas via the carbon dioxide hydrogenation reaction.

In addition, another embodiment of the present invention provides a method for producing synthesis gas utilizing the catalyst (a method for preparing synthesis gas via a Reverse Water Gas Shift reaction).

In addition, another embodiment of the present invention provides a Reverse Water Gas Shift reaction system.

The technical objects to be achieved by the present invention are not limited to the technical objects mentioned above, and other unmentioned technical objects will be clearly understood by one of ordinary skill in the art to which the present invention pertains from the following description.

As a technical means for achieving the aforementioned technical objects, one aspect of the present invention provides a Reverse Water Gas Shift (RWGS) reaction catalyst, comprising: a composite metal oxide support; and metal or metal oxide nanoparticles dispersed on a surface of the composite metal oxide support or within pores thereof, wherein the composite metal oxide support is derived from a layered double hydroxide comprising copper and at least two metals different from copper, and the metal nanoparticles are reduced from the composite metal oxide support.

The content of copper may be 10 to 70 parts by weight, based on 100 parts by weight of the composite metal catalyst.

The catalyst may comprise magnesium as a first metal and iron as a second metal, and based on 100 parts by weight of the composite metal catalyst, a content of the first metal may be 4 to 40 parts by weight, and a content of the second metal may be 10 to 30 parts by weight.

The catalyst may comprise aluminum as a third metal, and based on 100 parts by weight of the composite metal catalyst, a content of the third metal may be 5 to 12 parts by weight.

A BET surface area of the Reverse Water Gas Shift reaction catalyst may be 30 to 160 m²/g.

A total pore volume of the Reverse Water Gas Shift reaction catalyst may be greater than 0.30 cm³/g and less than or equal to 0.8 cm³/g.

The metal nanoparticles may be nanoparticles of at least one transition metal selected from the group consisting of magnesium, aluminum, iron, manganese, nickel, cobalt, titanium, and zinc.

The support may have a porous structure.

Another aspect of the present invention provides a method for preparing a Reverse Water Gas Shift reaction catalyst, the method comprising the steps of: preparing a first solution by preparing and mixing a copper precursor and precursors of at least two different metals; preparing a second solution comprising a carbonate precursor; mixing the first and second solutions, and a base to obtain a first mixture; aging the first mixture; separating a precipitate of the aged first mixture; drying the precipitate to obtain a layered double hydroxide; and heat-treating the layered double hydroxide.

The method may further comprise, after the step of heat-treating the layered double hydroxide, a step of: reducing in the presence of a gas comprising an inert gas.

In the step of preparing the first solution, a ratio of a number of moles of copper to a sum of a number of moles of the at least two metals may be 0.3:1 to 3:1.

In the step of obtaining the first mixture by mixing the first and second solutions and the base, a pH of the first mixture solution may be 8 to 11 after the base is introduced.

The step of aging the first mixture may be performed by stirring for 6 to 48 hours at a temperature of 40° C. to 80° C.

The step of drying the precipitate to obtain a layered double hydroxide may be performed at a temperature of 80° C. to 150° C.

The step of heat-treating the layered double hydroxide may be performed at 400° C. to 800° C. for 1 to 6 hours.

The step of reducing in the presence of the gas comprising an inert gas may be performed at 300° C. to 450° C.

Another aspect of the present invention provides a method for preparing a synthesis gas via a Reverse Water Gas Shift reaction, the method comprising the steps of: preparing the Reverse Water Gas Shift reaction catalyst according to the method; and generating a synthesis gas comprising carbon monoxide by introducing a reaction gas comprising carbon dioxide and hydrogen in the presence of the Reverse Water Gas Shift reaction catalyst.

According to an embodiment of the present invention, a non-precious metal-based Reverse Water Gas Shift reaction catalyst having high carbon dioxide conversion efficiency and carbon monoxide selectivity at a low temperature of 450° C. or lower can be provided.

In addition, according to an embodiment of the present invention, a method for preparing the non-precious metal-based Reverse Water Gas Shift reaction catalyst through a co-precipitation method, which is a simple bottom-up method, can be provided.

The effects of the present invention are not limited to the effects described above, and it should be understood that they include all effects that can be inferred from the configuration of the invention described in the description or claims of the present invention.

### BRIEF DESCRIPTION OF THE DRAWINGS

FIG. 1 schematically illustrates a manufacturing process of a layered double hydroxide-derived Reverse Water Gas Shift reaction catalyst according to an embodiment of the present invention.

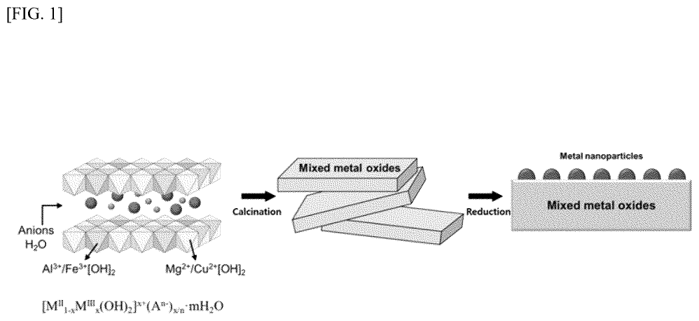

FIG. 2 shows experimental data comparing the catalytic activity according to the metal composition of the catalyst according to an embodiment of the present application.

FIG. 3 shows experimental data comparing the stability according to the metal composition of the catalyst according to an embodiment of the present application.

### DETAILED DESCRIPTION

Hereinafter, the present invention will be described in more detail. However, the present invention may be embodied in many different forms and should not be construed as limited to the embodiments set forth herein; rather, the present invention is to be defined only by the claims that will be described later.

Furthermore, the terminology used in the present invention is for the purpose of describing particular embodiments only and is not intended to be limiting of the present invention. A singular expression includes a plural expression unless the context clearly indicates otherwise. Throughout the specification of the present invention, that a certain component ‘comprises’ something signifies that it may further include other components, rather than excluding other components, unless there is a specific description to the contrary.

Throughout the specification, when a part is referred to as being “connected (in contact, coupled)” to another part, this includes not only cases where it is “directly connected” but also cases where it is “indirectly connected” with another member interposed therebetween. Furthermore, when a part is referred to as “comprising” a certain component, this means that it may further comprise other components, rather than excluding other components, unless there is a specific description to the contrary.

Throughout the specification, in the case of the expression “%”, it may mean content by weight unless otherwise specified, and in a case where a basis is separately described or recited, it may be in accordance with the corresponding recitation or description.

In the present specification, the term “Reverse Water Gas Shift (RWGS) reaction” may mean an endothermic reaction that uses carbon dioxide (CO2) and hydrogen (H2) as reactants to obtain carbon monoxide (CO) and water (H2O) as products, or to obtain carbon monoxide, water, and methane as products. The products may be selected according to thermodynamic equilibrium. The main reaction of the Reverse Water Gas Shift reaction is as follows: CO₂(g)+H₂(g)↔CO(g)+H₂O (g), and a methanation reaction may occur as a side reaction thereof.

In the present specification, the term “calcination” may mean heating to high temperatures in air or oxygen. In the present invention, a heat treatment, that is, a calcination treatment, may be performed to oxidize the catalyst with air at a high temperature.

The terminology used in the present specification is for the purpose of describing particular embodiments only and is not intended to be limiting of the present invention. A singular expression includes a plural expression unless the context clearly indicates otherwise.

A first aspect of the present invention provides a Reverse Water Gas Shift (RWGS) reaction catalyst, comprising: a composite metal oxide support; and metal or metal oxide nanoparticles dispersed on a surface of the composite metal oxide support or within pores thereof, wherein the composite metal oxide support is derived from a layered double hydroxide comprising copper and at least two metals different from copper, and the metal nanoparticles are reduced from the composite metal oxide support.

Hereinafter, the Reverse Water Gas Shift (RWGS) reaction catalyst according to the first aspect of the present invention will be described in detail.

In an embodiment of the present invention, the composite metal oxide support may be derived from a layered double hydroxide (LDH), which is an artificially synthesizable, ionic clay-like material in the form of a regular hexahedron, composed of layers of divalent and trivalent cations and having a two-dimensional nanostructure into which various anions can be intercalated between the layers. Because it has a structure similar to that of hydrotalcite (Mg₆Al₂(OH)₁₆CO₃-4H₂O), a mineral in the natural world, it is also called a hydrotalcite-like compound. The chemical formula of LDH is generally expressed as [M²⁺₁₋ₓM³⁺ₓ (OH)₂]^{x+}[(A^{m-})_{x/m}-nH₂O]^{x-}, wherein the divalent cation, M², may be composed of a metal such as magnesium (Mg), zinc (Zn), iron (Fe), titanium (Ti), nickel (Ni), or copper (Cu), and the trivalent cation, M³, may be composed of a metal such as aluminum (Al), chromium (Cr), or calcium (Ca). For A^{m-}, which is intercalated between the layers, many organic and inorganic anions such as OH—, Cl—, NO3⁻, SO₄²⁻ may be intercalated.

The catalyst according to an embodiment of the present invention may mean a catalyst in which, in the process of preparing the layered double hydroxide as a precursor of the support, not only one metal is used as the divalent cation, but a ternary or quaternary layered double hydroxide is formed, and thereafter, a composite metal oxide is first formed through oxidation, and then a heat treatment for reduction is performed, such that exsolved metal particles are dispersed and distributed on the ternary or quaternary composite metal oxide support derived from the layered double hydroxide. Preferably, in the case of the ternary or quaternary composite metal oxide, it may comprise magnesium as a first metal and iron as a second metal, and if included, may comprise aluminum as a third metal.

In particular, copper metal is reported to have high efficiency for the hydrogenation reaction of carbon dioxide and to suppress methane formation in a low-temperature region of 200 to 300° C., and thus can be utilized as an active material of a non-precious metal-based low-temperature RWGS catalyst; however, pure copper metal has almost no catalytic activity, and particles of a small size must exist in a uniformly dispersed state. In addition, there is a limitation in that the conversion of carbon dioxide is not high compared to precious metal-based catalysts, and there was a problem in that with copper-based RWGS catalysts, a possibility of catalyst deactivation exists in a long-duration reaction due to the phenomenon of sintering or carbon deposition (coke formation). Furthermore, when using a conventional support material such as silica or alumina, it was difficult to control the degree of dispersion of the copper metal, and by utilizing only copper as an active material of the catalyst, there was a problem of low activity compared to existing precious metal-based catalysts. Therefore, in the case of the catalyst according to an embodiment of the present invention, the catalyst essentially comprises copper, may further comprise at least one of additional first to third metals, is manufactured to be a catalyst characterized in that composite metal particles are uniformly dispersed on the surface, and may be characterized in that the activity or stability effect of such a catalyst is excellent.

In an embodiment of the present invention, the manufacturing process of the layered double hydroxide may use a co-precipitation method or a hydrothermal synthesis method, and preferably, the co-precipitation method may be utilized.

In an embodiment of the present invention, the content of copper may be 10 to 70 parts by weight based on 100 parts by weight of the composite metal catalyst, and if the content is less than the above-described range, the active temperature of the catalyst may not be formed at a desired temperature, or there is a possibility that the object of the present invention of preparing a non-precious metal-based catalyst may not be sufficiently achieved, and if the content exceeds the above-described range, an insufficient effect may be exhibited in terms of the stability or activity of the catalyst.

In an embodiment of the present invention, the catalyst may comprise magnesium as a first metal and iron as a second metal, and based on 100 parts by weight of the composite metal catalyst, a content of the first metal may be 4 to 40 parts by weight, and a content of the second metal may be 10 to 30 parts by weight. If the content is less than the above-described range, it may not exhibit activity as composite metal particles, and if the content exceeds the above-described range, it may hinder the catalytic activity of the copper metal, and thus may show an adverse effect on the overall activity of the catalyst.

In an embodiment of the present invention, the catalyst may further comprise aluminum as a third metal, and this may be for improving the stability or durability of the catalyst. Based on 100 parts by weight of the composite metal catalyst, a content of the third metal may be 5 to 12 parts by weight, and if the content is less than the above-described range, an improvement in the stability or durability of the catalyst may not be expected at all, and if the content exceeds the above-described range, there is a possibility that it may act as an impurity, such that a problem may occur in which the reaction activity of the catalyst is decreased.

In an embodiment of the present invention, the BET surface area of the Reverse Water Gas Shift reaction catalyst may be 9 m²/g or more, 15 m²/g or more, 22.5 m²/g or more, 27 m²/g or more, 30 m²/g or more, or 36 m²/g or more, and may be 400 m²/g or less, 320 m²/g or less, 240 m²/g or less, 240 m²/g or less, 200 m²/g or less, or 160 m²/g or less. If the surface area exceeds the above-described range, the volume of the composite catalyst may become unnecessarily large, or a required level of strength may not be secured, and if the surface area is less than the above-described range, a decrease in the activity or efficiency of the reaction may appear.

In an embodiment of the present invention, the catalyst may have a porous structure, and specifically, may simultaneously comprise micropores and mesopores. The total pore volume of the composite metal catalyst may be defined as the sum of the micropore volume and the mesopore volume, and other pore volumes may be further included. Specifically, the total pore volume of the composite metal catalyst may be greater than 0.09 cm³/g, 0.15 cm³/g or more, 0.225 cm³/g or more, 0.27 cm³/g or more, 0.30 cm³/g or more, or 0.36 cm³/g or more, and may be 2.0 cm³/g or less, 1.6 cm³/g or less, 1.2 cm³/g or less, or 1.0 cm³/g or less, or 0.8 cm³/g or less. If the volume exceeds the above-described range, the volume of the composite metal catalyst may become unnecessarily large, or a required level of strength may not be secured, and if the volume is less than the above-described range, a decrease in reaction efficiency may appear.

In an embodiment of the present invention, the shape of the metal nanoparticles may be at least one selected from the group consisting of spherical, hemispherical, plate-like, cylindrical, and a polyhedron comprising flat surfaces, and may preferably be composed of hemispherical, a polyhedron comprising flat surfaces, and a combination thereof.

In an embodiment of the present invention, the metal dispersion of the metal nanoparticles may be measured through N2O-chemisorption analysis and may be 0.9% or more, 1.5% or more, 2.25% or more, 2.7% or more, 3% or more, or 3.6% or more, and may be 37.5% or less, 30% or less, 22.5% or less, 22.5% or less, 18.75% or less, or 15% or less. If the dispersion is less than the above range, the dispersion of the metal nanoparticles may not be sufficiently achieved, such that reaction activity may not be properly secured, and if the dispersion exceeds the above range, the process for uniform dispersion may be prolonged unnecessarily, which may be inefficient from the viewpoint of energy.

In an embodiment of the present invention, the sum of the dispersed area of the metal nanoparticles with respect to the total area of the Reverse Water Gas Shift reaction catalyst may be 0.15% or more, 0.25% or more, 0.375% or more, 0.45% or more, 0.5% or more, or 0.6% or more, and may be 125% or less, 100% or less, 75% or less, 75% or less, 62.5% or less, or 50% or less. If the sum is less than the above range, the reaction activity may be insufficient because the dispersion of the metal nanoparticles has not been sufficiently achieved, and if the sum exceeds the above range, it may mean aggregates rather than being dispersed in units of nanoparticles, and thus, may similarly be considered to hinder the activity.

In an embodiment of the present invention, the Reverse Water Gas Shift reaction catalyst may be a product that has undergone a reduction reaction in a hydrogen and/or inert gas environment prior to the reaction.

In an embodiment of the present invention, the Reverse Water Gas Shift reaction catalyst may have high carbon monoxide conversion activity at a low temperature. Specifically, with the catalyst, the temperature at which the carbon monoxide yield (which is the same as the carbon dioxide conversion rate at 100% selectivity) is 30% may be 430° C. or less. Although this characteristic will be demonstrated by the Examples described later, a carbon dioxide conversion of 30% or more can be achieved at a temperature lower by as much as 50° C. or more compared to a conventional commercially available alumina support-based catalyst.

A second aspect of the present invention provides a method for preparing a Reverse Water Gas Shift reaction catalyst, the method comprising the steps of: preparing a first solution by preparing and mixing a copper precursor and precursors of at least two different metals; preparing a second solution comprising a carbonate precursor; mixing the first and second solutions, and a base to obtain a first mixture; aging the first mixture; separating a precipitate of the aged first mixture; drying the precipitate to obtain a layered double hydroxide; and heat-treating the layered double hydroxide.

Regarding the parts that overlap with the first aspect of the present invention, a detailed description thereof has been omitted, but the content described for the first aspect may be equally applied to the second aspect even if its description is omitted in the second aspect.

Hereinafter, the method for preparing a Reverse Water Gas Shift reaction catalyst according to the second aspect of the present invention will be described in detail.

First, in an embodiment of the present invention, the method may comprise a step of preparing a first solution by separately preparing and mixing a copper precursor and precursors of at least two different metals.

In an embodiment of the present invention, the copper precursor may be any conventional salt comprising copper without limitation, but is preferably Cu(NO₃)₂·3H₂O. In addition, in an embodiment of the present invention, if included, in a case where magnesium is used as an additional metal, the precursor of the metal may be any salt of magnesium without limitation, but is preferably Mg(NO₃)₂·6H₂O. In addition, in an embodiment of the present invention, if included, in a case where iron is used as an additional metal, the precursor of the metal may be any salt of iron without limitation, but is preferably Fe(NO₃)₂·9H₂O. In addition, in an embodiment of the present invention, if included, in a case where aluminum is used as an additional metal, the precursor of the metal may be any salt of aluminum without limitation, but is preferably Al(NO₃)₂·9H₂O.

In an embodiment of the present invention, in the step of preparing the first solution, the ratio of the number of moles of copper to the sum of the number of moles of the at least two metals may be 0.09:1 or more, 0.15:1 or more, 0.225:1 or more, 0.27:1 or more, 0.3:1 or more, or 0.36:1 or more, and may be 7.5:1 or less, 6:1 or less, 4.5:1 or less, 4.5:1 or less, 3.75:1 or less, or 3:1 or less. If the ratio is less than the above range, the reaction activity of the resulting catalyst may be insufficient because copper is not sufficiently included, and if the ratio exceeds the above range, it may become difficult to utilize the advantages as a multi-component catalyst.

Specifically, in an embodiment of the present invention, the molar ratio of copper to the first metal may be 0.06:1 or more, 0.1:1 or more, 0.15:1 or more, 0.18:1 or more, 0.2:1 or more, or 0.24:1 or more, and may be 12.5:1 or less, 10:1 or less, 7.5:1 or less, 7.5:1 or less, 6.25:1 or less, or 5:1 or less.

In addition, in another embodiment of the present invention, if the second metal is further included, the molar ratio of copper to the second metal may be 0.15:1 or more, 0.25:1 or more, 0.375:1 or more, 0.45:1 or more, 0.5:1 or more, or 0.6:1 or more, and may be 7.5:1 or less, 6:1 or less, 4.5:1 or less, 4.5:1 or less, 3.75:1 or less, or 3:1 or less. In addition, the molar ratio of the first metal to the second metal may be 0.15:1 or more, 0.25:1 or more, 0.375:1 or more, 0.45:1 or more, 0.5:1 or more, or 0.6:1 or more, and may be 7.5:1 or less, 6:1 or less, 4.5:1 or less, 4.5:1 or less, 3.75:1 or less, or 3:1 or less.

In addition, in another embodiment of the present invention, in a case of a four-component system in which the third metal is further included, the molar ratio of copper to the third metal may be 1.125:1 or more, 1.35:1 or more, 1.5:1 or more, or 1.8:1 or more, and may be 7.5:1 or less, 6:1 or less, 4.5:1 or less, 4.5:1 or less, 3.75:1 or less, or 3:1 or less. In addition, the molar ratio of the first metal to the third metal may be 1.125:1 or more, 1.35:1 or more, 1.5:1 or more, or 1.8:1 or more, and may be 7.5:1 or less, 6:1 or less, 4.5:1 or less, 4.5:1 or less, 3.75:1 or less, or 3:1 or less. In addition, the molar ratio of the second metal to the third metal may be 0.81:1 or more, 0.9:1 or more, or 1.08:1 or more, and may be 1.8:1 or less, 1.5:1 or less, or 1.2:1 or less.

By satisfying the above-described molar ratios between the multi-component metals, it becomes possible to realize catalyst properties that are optimized in terms of the activity and stability of the reaction.

Next, in an embodiment of the present invention, the method may comprise a step of preparing a second solution comprising a carbonate precursor.

In an embodiment of the present invention, the carbonate precursor may be used without limitation as a commonly used precursor as long as it is a metal salt comprising CO₃²⁻, but may preferably be a carbonate of an alkali metal or a carbonate of a transition metal, and more preferably may be Na₂CO₃.

In an embodiment of the present invention, in the case of the solvent used for preparing the first or second solution, polar or non-polar, organic or inorganic solvents may be utilized without limitation, but the solvent may preferably be deionized water or distilled water.

In an embodiment of the present invention, the carbonate precursor may be included in an amount less than the weight of the precursor of the first metal, and may preferably be included in an amount of 30 to 60 parts by weight based on 100 parts by weight of the first metal precursor.

Next, in an embodiment of the present invention, the method may comprise a step of mixing the first and second solutions, and a base to obtain a first mixture.

In an embodiment of the present invention, the step of obtaining the first mixture may be by a method of simultaneously and slowly adding the first solution and the second solution to an empty vessel, or by a method of adding the first or second solution to a vessel and then slowly adding the second or first solution. In addition, the base may also be mixed at the same time as the first solution and the second solution are mixed, or the base may be added separately after the addition of the first and second solutions is completed.

In an embodiment of the present invention, in the step of obtaining the first mixture by mixing the first and second solutions, and the base, the pH of the first mixture solution after adding the base may be 8 to 11. In addition, in an embodiment of the present invention, the type of the base is not limited, but a base that can adjust only the pH range to a basic range without significantly participating in the reaction may be preferably used, and more preferably, NaOH may be used.

Next, in an embodiment of the present invention, the method may comprise a step of aging the first mixture; and a step of separating a precipitate of the aged first mixture.

In an embodiment of the present invention, the step of aging the first mixture may be by stirring the mixed solution for a predetermined time under appropriate high-temperature conditions after the addition, including the base, is completed, and preferably, the step of aging the first mixture may be by stirring for 6 to 48 hours at a temperature of 40 to 80° C. In addition, in an embodiment of the present invention, the stirring may be characterized by stirring at a speed of 150 to 500 rpm. Although there is no great restriction on the shape of the impeller, a means capable of stirring at a speed of 200 to 300 rpm may preferably be utilized. Specifically, in an embodiment of the present invention, the stirring method is not limited, but the mixing method used in the present patent is a method using a magnetic bar, and although there is no great restriction on the shape of the impeller, various mixers such as a propeller type may be used.

In an embodiment of the present invention, the step of separating the precipitate of the aged first mixture may be a separation process utilizing filtration, centrifugation, etc., and a non-limiting method may be utilized under conditions that do not adversely affect the properties of the precipitate.

Next, in an embodiment of the present invention, the method may comprise a step of drying the precipitate to obtain a layered double hydroxide.

In an embodiment of the present invention, the method may comprise a step of drying the precipitate to obtain a layered double hydroxide. The drying temperature may be in a range of 60 to 150° C., and preferably 80 to 150° C. If the temperature exceeds the above temperature range, the rapid evaporation of moisture affects the pore size and volume of the catalyst. In addition, the drying is preferably performed until the solid content is completely dried, and more preferably, may be performed for 1 to 24 hours.

Next, in an embodiment of the present invention, the method may comprise a step of heat-treating the layered double hydroxide. The heat treatment may be a step of calcining. This step may mean a process of oxidizing the layered double hydroxide to convert it into an oxide support of multi-component metals, while generally maintaining the shape of the layered double hydroxide.

In an embodiment of the present invention, it is preferable that the calcination temperature is in a range of 400 to 800° C. If the temperature is less than the above temperature range, a problem may be caused in that sufficient oxidation of the layered double hydroxide into an oxide does not occur, and if the temperature exceeds the above temperature range, aggregation of sites of different metals on the surface may occur, and consequently, a problem may occur in which the catalytic activity is decreased.

In addition, in an embodiment of the present invention, it is preferable that the calcination is performed for 1 to 6 hours. If the time exceeds the above time range, it may be difficult to maintain appropriate reaction activity due to aggregation of the active metal, or it is inefficient from an energy viewpoint, and if the time is less than the above time range, the meaning of the calcination process itself will be lost because oxidation is not sufficiently achieved.

In an embodiment of the present invention, the method may further comprise, after the step of heat-treating the layered double hydroxide, a step of: reducing in the presence of a gas comprising an inert gas.

In an embodiment of the present invention, the step of reducing in the presence of the gas comprising an inert gas may be performed at 300 to 450° C. for 0.5 to 6 hours. In addition, it is preferable that the reduction step is performed in an H₂ gas atmosphere. The gas atmosphere of the reduction heat treatment process is not particularly limited, and the process may be performed in an atmosphere of pure hydrogen gas, or a mixed gas with an inert gas such as nitrogen or argon, and may preferably be performed under conditions of a hydrogen/nitrogen mixed gas with a hydrogen concentration by weight of 5 to 50%.

A third aspect of the present invention provides a method for preparing a synthesis gas via a Reverse Water Gas Shift reaction, the method comprising the steps of: preparing the Reverse Water Gas Gas Shift reaction catalyst according to the method; and generating a synthesis gas comprising carbon monoxide by introducing a reaction gas comprising carbon dioxide and hydrogen in the presence of the Reverse Water Gas Shift reaction catalyst.

Regarding the parts that overlap with the first and second aspects of the present invention, a detailed description thereof has been omitted, but the content described for the first and second aspects may be equally applied to the third aspect even if their description is omitted in the third aspect.

Hereinafter, the method for preparing a synthesis gas via a Reverse Water Gas Shift reaction according to the third aspect of the present invention will be described in detail.

In an embodiment of the present invention, in the step of generating a synthesis gas comprising carbon monoxide by introducing a reaction gas comprising carbon dioxide and hydrogen in the presence of the Reverse Water Gas Shift reaction catalyst, the reaction gas may comprise at least nitrogen, carbon dioxide, and hydrogen gases. In an embodiment of the present invention, the molar ratio of carbon dioxide to hydrogen may be 1:1 to 1:4. If the molar ratio of carbon dioxide to hydrogen (CO₂/H₂) is high, the carbon dioxide conversion may decrease, and if the molar ratio is low, the carbon dioxide conversion may increase, but the amount of hydrogen used increases, which may increase the cost of hydrogen.

In an embodiment of the present invention, the step of generating a synthesis gas comprising carbon monoxide by introducing a reaction gas comprising carbon dioxide and hydrogen in the presence of the Reverse Water Gas Shift reaction catalyst may be performed under temperature conditions of 300° C. to 600° C. If the reaction temperature is lower than 300° C., the carbon dioxide conversion may decrease, and if it exceeds 600° C., the stability of the catalyst may decrease. Considering that when a conventional Reverse Water Gas Shift reaction catalyst is used, the reaction is performed at a relatively high temperature in the range of 600° C. to 900° C., it can be confirmed that when the catalyst according to an embodiment of the present invention is utilized, the effect of making a process that exhibits high activity under relatively low-temperature conditions implementable is achieved.

A fourth aspect of the present invention provides a Reverse Water Gas Shift reaction system, comprising: a reaction vessel in which a catalyst is loaded; a reaction gas inlet provided at one end of the reaction vessel, into which hydrogen and carbon dioxide are respectively injected; and a synthesis gas outlet provided at the other end of the reaction vessel, from which the gas synthesized by the Reverse Water Gas Shift reaction is discharged.

Regarding the parts that overlap with the first to third aspects of the present invention, a detailed description thereof has been omitted, but the content described for the first to third aspects may be equally applied to the fourth aspect even if their description is omitted in the fourth aspect.

Hereinafter, embodiments of the present invention will be described in detail so that one of ordinary skill in the art to which the present invention pertains can easily practice them. However, the present invention may be embodied in many different forms and should not be construed as limited to the embodiments set forth herein.

### Example 1: Preparation of Reverse Water Gas Shift Reaction Catalyst

A copper-comprising layered double hydroxide was synthesized by a co-precipitation method. First, Solution A was prepared by adding a copper precursor (Cu(NO₃)₂·3H₂O) and an iron precursor (Fe(NO₃)₂·9H₂O) to 200 mL of distilled water at a molar ratio of 3:1, and Solution B was prepared by adding a carbonate precursor (Na₂CO₃) in an amount corresponding to half the moles of the iron precursor to 50 mL of distilled water. Solution A and Solution B were simultaneously and slowly added to an empty beaker. At this time, an NaOH solution was added at an appropriate rate to maintain the pH of the mixed solution at 10 to 11. After the addition of the solutions was completed, the mixed solution was aged by stirring at 60° C. for 24 hours. After the aging was completed, the solution in a slurry state was filtered to separate a precipitate, which was then sufficiently washed with distilled water. The separated and washed precipitate was completely dried at a high temperature of 100° C. to obtain the copper-comprising layered double hydroxide. This was heat-treated at 500° C. for 3 hours to prepare a layered double hydroxide-based metal oxide.

### Example 2: Preparation of Reverse Water Gas Shift Reaction Catalyst

A catalyst was prepared using a Solution A having a composition with a molar ratio of copper:magnesium:iron of 2.5:0.5:1. In this case, the magnesium precursor used was Mg(NO₃)₂·6H₂O. The rest of the synthesis process was performed in the same manner as in Example 1.

### Example 3: Preparation of Reverse Water Gas Shift Reaction Catalyst

A catalyst was prepared using a Solution A having a composition with a molar ratio of copper:magnesium:iron of 1.5:1.5:1. In this case, the magnesium precursor used was Mg(NO₃)₂·6H₂O. The rest of the synthesis process was performed in the same manner as in Example 1.

### Example 4: Preparation of Reverse Water Gas Shift Reaction Catalyst

A catalyst was prepared using a Solution A having a composition with a molar ratio of copper:magnesium:iron of 0.5:2.5:1. In this case, the magnesium precursor used was Mg(NO₃)₂·6H₂O. The rest of the synthesis process was performed in the same manner as in Example 1.

### Example 5: Preparation of Reverse Water Gas Shift Reaction Catalyst

A catalyst was prepared using a Solution A having a composition with a molar ratio of magnesium:iron of 3:1. In this case, the magnesium precursor used was Mg(NO₃)₂·6H₂O. The rest of the synthesis process was performed in the same manner as in Example 1.

### Example 6: Preparation of Reverse Water Gas Shift Reaction Catalyst

A catalyst was prepared using a Solution A having a composition with a molar ratio of copper:magnesium:aluminum of 1.5:1.5:1. In this case, the aluminum precursor used was Al(NO₃)₂·9H₂O. The rest of the synthesis process was performed in the same manner as in Example 1.

### Example 7: Preparation of Reverse Water Gas Shift Reaction Catalyst

A catalyst was prepared using a Solution A having a composition with a molar ratio of copper:magnesium:aluminum:iron of 1.5:1.5:0.5:0.5. In this case, the aluminum precursor used was Al(NO₃)₂·9H₂O. The rest of the synthesis process was performed in the same manner as in Example 1.

### Comparative Example 1: Preparation of Commercial Reverse Water Gas Shift Reaction Catalyst

A commercially available Cu/ZnO/Al₂O₃ catalyst (MDC-7) from Clariant was prepared.

The content of the catalysts of the completed Examples 1 to 7 and Comparative Example 1 was measured by ICP-OES, and in the case of the surface properties, they were measured through N₂ isothermal adsorption at −196° C.; the surface area was obtained according to the BET method, and the pore properties were calculated according to the BJH method. The measured results are as shown in Table 1 below.

TABLE 1

| | | | | | | Surface properties ² | | Metal particle | |
|---|---|---|---|---|---|---|---|---|---|
| | | | | | | Surface | Pore | properties | |
| | Content (wt %) ¹ | | | | | area | volume | Dispersion | Area |
| | Cu | Mg | Fe | Al | Zn | (m²/g_{cat}) ⁴ | (cm³/g_{cat}) ⁵ | (%) | (m²/g_{cat})) |
| Example 1 | 77.8 | 0 | 21.2 | — | — | 25.5 | 0.307 | 0.13 | 0.54 |
| Example 2 | 71.1 | 4.65 | 23.4 | — | — | 39.6 | 0.397 | 4.33 | 21.35 |
| Example 3 | 45.6 | 16.8 | 26.3 | — | — | 62.6 | 0.771 | 9.90 | 39.14 |
| Example 4 | 15.9 | 30.4 | 27.6 | — | — | 71.6 | 0.737 | 11.85 | 28.48 |
| Example 5 | 0 | 39.6 | 30.1 | — | — | 56.6 | 0.776 | 7.01 | 13.39 |
| Example 6 | 38.1 | 13.5 | — | 11.2 | — | 154.5 | 0.669 | 9.86 | 25.4 |
| Example 7 | 37.3 | 13.2 | 10.1 | 5.58 | — | 86.9 | 0.371 | 19.9 | 63.6 |
| Comparative | 34.5 | — | — | 5.32 | 36.7 | 75.9 | 0.210 | 6.94 | 14.3 |
| Example 1 | | | | | | | | | |

### Experimental Example 1: Reaction Activity Test

To evaluate the RWGS reaction activity, a catalyst having a particle size of 150 to 250 prn was selected. 50 mg of the catalyst and 1 g of a diluent were mixed and packed in the central part of a quartz reactor. The temperature of the catalyst bed was confirmed through a K-type thermocouple.

Before the reaction, the catalyst was reduced by flowing 100 mL/min of a mixed gas of 10% H₂/N₂ at 400° C. Thereafter, the temperature was set to 300° C. in an N₂ atmosphere, and a stabilization period of 1 hour was provided.

The RWGS reaction was measured at intervals of 25° C. in a temperature range of 300 to 450° C. The reaction was maintained for 2 hours at each temperature, and the carbon dioxide conversion, carbon monoxide selectivity, and carbon monoxide yield were calculated by obtaining the average of the reactant composition during the final 1 hour. At this time, the composition of the reaction gas was set to 60 mol % H₂, 15 mol % CO₂, and 25 mol % N₂, and the space velocity was set to 360,000 mL/g_{cat} h. The reaction activity calculation formulas are as follows.

$$Carbon dioxide conversion ( \% ) = \frac{{[ CO ]}_{out} + {[ {CH}_{4} ]}_{out}}{{[ {CO}_{2} ]}_{out} + {[ CO ]}_{out} + {[ {CH}_{4} ]}_{out}} \times 100$$

$$Carbon monoxide selectivity ( \% ) = \frac{{[ CO ]}_{out}}{{[ CO ]}_{out} + {[ {CH}_{4} ]}_{out}} \times 100$$

$$Carbon monoxide yield ( \% ) = \frac{{[ CO ]}_{out}}{{[ {CO}_{2} ]}_{out} + {[ CO ]}_{out} + {[ {CH}_{4} ]}_{out}} \times 100$$

The RWGS reaction activity and selectivity of the catalysts of Examples 1 to 7 and Comparative Example 1 according to the metal composition were compared and are shown in Table 2 below (Reduction temperature: 400° C., GHSV=360,000 mL·gcat-1h-1, Reaction temperature: 350° C., H₂/CO₂=4).

TABLE 2

| | | | Carbon |
|---|---|---|---|
| | Carbon dioxide | Carbon monoxide | monoxide |
| | conversion (%) | selectivity (%) | yield (%) |
| Example 1 | 1.32 | 100 | 1.32 |
| Example 2 | 7.49 | 100 | 7.49 |
| Example 3 | 17.09 | 100 | 17.09 |
| Example 4 | 11.27 | 100 | 11.27 |
| Example 5 | 0.50 | 100 | 0.50 |
| Example 6 | 19.87 | 100 | 19.87 |
| Example 7 | 29.22 | 100 | 29.22 |
| Comparative | 11.05 | 100 | 11.05 |
| Example | | | |

Referring to Table 1, it was confirmed that in the case of Examples 3, 6, and 7, the carbon dioxide conversion was higher compared to the Comparative Example, and since the carbon monoxide selectivity was 100%, it was also confirmed that in the case of the carbon monoxide yield, the reaction activity for Examples 3, 6, and 7 was at a high level compared to the commercially available catalyst.

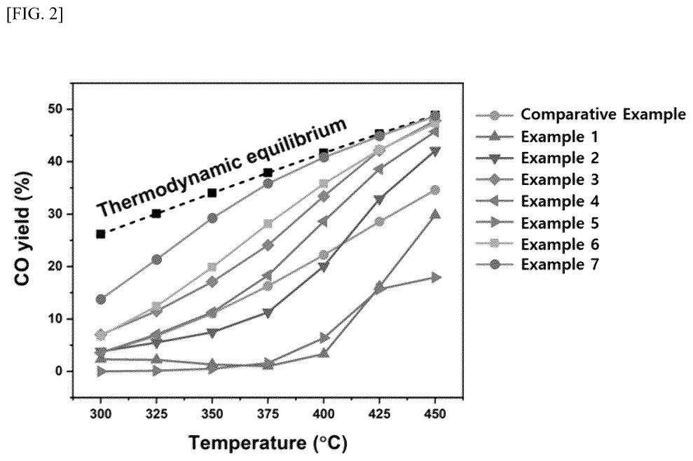

FIG. 2 shows experimental data comparing the catalytic activity according to the metal composition of the catalyst according to an embodiment of the present invention. The experimental conditions are as follows.

$$( Reduction temperature : 400 ° C . , GHSV = 360 , 000 mL \cdot {gcat}^{- 1} {h}^{- 1} , Reaction temperature : 300 to 450 ° C . , {H}_{2} / {CO}_{2} = 4 )$$

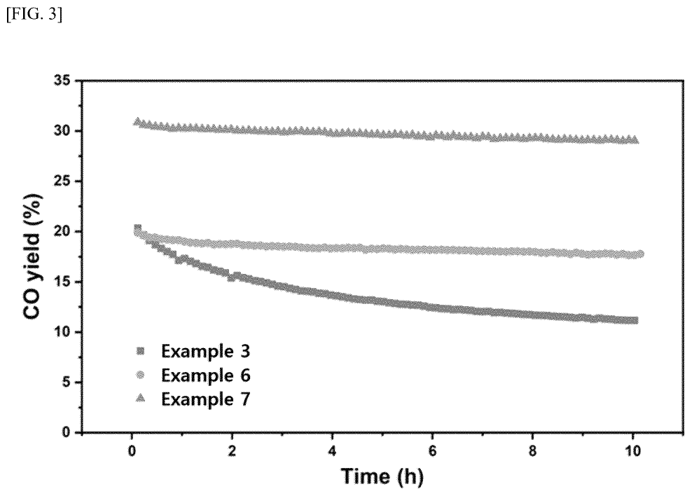

FIG. 3 shows experimental data comparing the stability according to the metal composition of the catalyst according to an embodiment of the present invention. The experimental conditions are as follows.

$$( Reduction temperature : 400 ° C . , GHSV = 360 , 000 mL \cdot {gcat}^{- 1} {h}^{- 1} , Reaction temperature : 350 ° C . , {H}_{2} / {CO}_{2} = 4 )$$

Referring to FIG. 2, it could be seen that a difference in catalytic activity occurs according to the components and composition of the metal catalyst. Specifically, Example 7, which is a four-component catalyst, had the greatest catalyst activity, and it was confirmed that Examples 2, 3, 4, and 6, which are three-component catalysts, could also exhibit high activity compared to the catalyst of Comparative Example 1. In the case of the two-component catalyst Examples, they showed a slightly lower level of activity compared to the commercial catalyst of the Comparative Example.

Referring to FIG. 3, it was confirmed that when aluminum (Al) is comprised as metal nanoparticles, the effect of increasing the stability of the catalyst over time is shown.

The foregoing description of the present invention is for illustrative purposes, and it will be understood by one of ordinary skill in the art to which the present invention pertains that it can be easily modified into other specific forms without changing the technical spirit or essential features of the present invention. Therefore, the embodiments described above must be understood as being illustrative in all aspects and not limiting. For example, each component described as being of a single type may also be implemented in a distributed manner, and likewise, components described as being distributed may also be implemented in a combined form.

The scope of the present invention is indicated by the claims set forth below, and all changes or modified forms derived from the meaning and scope of the claims and their equivalents should be interpreted as being included within the scope of the present invention.

What is claimed is:

1. A Reverse Water Gas Shift (RWGS) reaction catalyst, comprising:
a composite metal oxide support; and
metal or metal oxide nanoparticles dispersed on a surface of the composite metal oxide support or within pores thereof,
wherein the composite metal oxide support is derived from a layered double hydroxide comprising copper and at least two metals different from copper, and
wherein the metal nanoparticles are reduced from the composite metal oxide support.

2. The catalyst of claim 1, wherein a content of the copper is 10 to 70 parts by weight, based on 100 parts by weight of the catalyst.

3. The catalyst of claim 2, comprising magnesium as a first metal and iron as a second metal, wherein based on 100 parts by weight of the catalyst, a content of the first metal is 4 to 40 parts by weight, and a content of the second metal is 10 to 30 parts by weight.

4. The catalyst of claim 3, further comprising aluminum as a third metal, wherein based on 100 parts by weight of the catalyst, a content of the third metal is 5 to 12 parts by weight.

5. The catalyst of claim 1, wherein a BET surface area of the catalyst is 30 to 160 m²/g.

6. The catalyst of claim 1, wherein a total pore volume of the catalyst is greater than 0.30 cm³/g and less than or equal to 0.8 cm³/g.

7. The catalyst of claim 1, wherein the metal nanoparticles are nanoparticles of at least one transition metal selected from the group consisting of magnesium, aluminum, iron, manganese, nickel, cobalt, titanium, and zinc.

8. A method for preparing a Reverse Water Gas Shift (RWGS) reaction catalyst, the method comprising the steps of:
preparing a first solution by preparing and mixing a copper precursor and precursors of at least two different metals;
preparing a second solution comprising a carbonate precursor;
mixing the first and second solutions, and a base to obtain a first mixture;
aging the first mixture;
separating a precipitate of the aged first mixture;
drying the precipitate to obtain a layered double hydroxide; and
heat-treating the layered double hydroxide.

9. The method of claim 8, further comprising, after the step of heat-treating the layered double hydroxide, a step of:
reducing in the presence of a gas comprising an inert gas.

10. The method of claim 8, wherein in the step of preparing the first solution, a ratio of a number of moles of copper to a sum of a number of moles of the at least two metals is 0.3:1 to 3:1.

11. The method of claim 8, wherein in the step of obtaining the first mixture by mixing the first and second solutions and the base, a pH of the first mixture solution is 8 to 11 after the base is introduced.

12. The method of claim 8, wherein the step of aging the first mixture is performed by stirring for 6 to 48 hours at a temperature of 40° C. to 80° C.

13. The method of claim 8, wherein the step of heat-treating the layered double hydroxide is performed at 400° C. to 800° C. for 1 to 6 hours.

14. The method of claim 8, wherein the step of reducing in the presence of the gas comprising an inert gas is performed at 300° C. to 450° C.

15. A method for preparing a synthesis gas via a Reverse Water Gas Shift reaction, the method comprising the steps of:
preparing the Reverse Water Gas Shift reaction catalyst according to the method of claim 8; and
generating a synthesis gas comprising carbon monoxide by introducing a reaction gas comprising carbon dioxide and hydrogen in the presence of the Reverse Water Gas Shift reaction catalyst.
